(19) United States
(12) Patent Application Publication
(10) Pub. No.: US 2025/0301960 A1
(43) Pub. Date: Oct. 2, 2025

(54) METHOD FOR DETERMINING PROPER PLANT SPACING FOR VEGETATION ECOLOGICAL RESTORATION IN ARID REGION

(71) Applicant: China Institute of Water Resources and Hydropower Research, Beijing (CN)

(72) Inventors: Yong WANG, Beijing (CN); Minjian CHEN, Beijing (CN); Fan HE, Beijing (CN); Yong ZHAO, Beijing (CN); Yuan LIU, Beijing (CN); Long YAN, Beijing (CN); Wei DENG, Beijing (CN); Yongnan ZHU, Beijing (CN); Fei ZHOU, Beijing (CN); Zhi XU, Beijing (CN)

(73) Assignee: China Institute of Water Resources and Hydropower Research, Beijing (CN)

(21) Appl. No.: 19/093,333

(22) Filed: Mar. 28, 2025

(30) Foreign Application Priority Data
Mar. 29, 2024 (CN) 202410370384.X

(51) Int. Cl. A01G 7/00; A01G 22/00; G06Q 10/063

(52) U.S. Cl. CPC A01G 7/00; A01G 22/00; G06Q 10/063

(57) ABSTRACT

Provided is a method for determining a proper plant spacing for vegetation ecological restoration in an arid region. The method includes the following steps: step 1, acquiring soil parameters and soil water parameters in a survey region; step 2, determining vegetation parameters for the survey region; step 3, collecting hydrological data of the survey region; step 4, determining a transpiration of a dominant plant species in a vegetation community of the survey region; step 5, calculating a thickness of a shallow groundwater action layer in the survey region; step 6, determining a thickness of an available water absorption layer; step 7, determining a water content within the thickness of the available water absorption layer; and step 8, determining the proper plant spacing for a vegetation. The method can effectively solve the problem of desertification of oases in arid regions.

### CROSS REFERENCE TO THE RELATED APPLICATIONS

This application is based upon and claims priority to Chinese Patent Application No. 202410370384.X, filed on Mar. 29, 2024, the entire contents of which are incorporated herein by reference.

### TECHNICAL FIELD

The present disclosure belongs to the technical field of vegetation ecological restoration, and in particular relates to a method for determining a proper plant spacing for vegetation ecological restoration in an arid region.

### BACKGROUND

Desertification poses a major threat to the ecosystems and agricultural safety in the arid and semi-arid regions of China. Determining a proper scale for vegetation restoration according to local conditions is of great significance for guiding the ecological rehabilitation, preventing the degradation of oases, and improving the ecological environment. Particularly in the arid and semi-arid regions of Northwest China, due to scarce precipitation, there is the patchy or striped spatial distribution of vegetations under water stress, and the vegetation undergoes a self-thinning or aggregation phenomenon under the driving of precipitation and groundwater, resulting in the local death in vegetation that is previously uniform. Therefore, the deep understanding of vegetation distribution patterns and formation and stability mechanisms thereof in arid regions and the exploration of proper plant spacings for vegetation restoration in arid regions are scientific issues that need to be urgently addressed in the ecological rehabilitation efforts.

Currently, the common technical method for analyzing a spatial distribution pattern of vegetations in an arid region is the coupling of a mathematical model (such as a Turing model, a kernel-based short-range cooperation and long-range inhibition interaction mechanism, a differential flow instability model, and a stochastic model of noise-induced pattern formation) with a soil moisture model. However, these mathematical models primarily focus on the exploration of changes in vegetation distribution patterns from the perspective of spatial dynamics, and most studies rely on historical vegetation biomass or spatial distribution data to predict the future vegetation distribution pattern evolution. Moreover, the coupling of a mathematical model with a process model is fraught with uncertainties, and there are shortcomings such as inadequate consideration of limiting factors (such as nutrients, soil moisture, and groundwater) and the heavy reliance on practical verification on site. Therefore, when the above technical method is used to determine a suitable plant spacing for a vegetation and guide the ecological restoration, there are notable drawbacks. The Chinese patent CN101120640B discloses a computational method for aggregated cultivation of cotton in an arid region. In this patent, the principle of aggregated distribution of desert plants adapted to harsh arid environments is analyzed, and it is recommended accordingly that a uniform planting pattern of cotton is changed to a 2-row stripped planting pattern. This method allows the concentrated application of water and fertilizers without increasing the consumption of irrigating water, thereby improving the cotton output in arid regions. However, there is currently no universal method proposed from the perspective of water stress to determine suitable plant spacings for various vegetation types in arid regions.

### SUMMARY

An objective of the present disclosure is to provide a method for determining a proper plant spacing for vegetation ecological restoration in an arid region, so as to solve the above technical problems.

In order to achieve the above objective, the present disclosure provides the following technical solutions:

The present disclosure discloses a method for determining a proper plant spacing for vegetation ecological restoration in an arid region, including the following steps:
step 1, acquisition of soil parameters and soil water parameters in a survey region: selecting a transition zone in the arid region as the survey region, and acquiring the soil parameters and the soil water parameters in the survey region, where the soil parameters include a soil water content, a soil effective grain diameter, and a soil porosity above a water table and the soil water parameters include a soil water temperature and a soil water surface tension;
step 2, determination of vegetation parameters for the survey region: determining the vegetation parameters for the survey region, including a thickness D of a vegetation root zone in the survey region;
step 3, collection of hydrological data of the survey region: collecting the hydrological data of the survey region, including a precipitation P and a groundwater depth H in the survey region;
step 4, determination of a transpiration of a dominant plant species in a vegetation community of the survey region: measuring the transpiration E of the dominant plant species in the vegetation community of the survey region;
step 5, calculation of a thickness of a shallow groundwater action layer in the survey region: calculating the thickness h of the shallow groundwater action layer in the survey region based on a theoretical equation for maximum capillary rising height, where the shallow groundwater action layer is formed by groundwater under a capillary action and the theoretical equation is as follows:

$$h = \frac{2 σ ( \overline{T} )}{ρ g [ 1.6 ( n - 39.5 \% ) + 0.0774 ] d} \qquad ( 1 )$$

where h represents the thickness of the shallow groundwater action layer in the survey region; T̅ represents an average soil water temperature; σ represents the soil water surface tension; p represents a density of water; g represents an acceleration due to gravity; n represents the soil porosity; and d represents the soil effective grain diameter;
step 6, determination of a thickness of an available water absorption layer: determining a superimposed thickness of the vegetation root zone and the shallow groundwater action layer, which is the thickness m of the available water absorption layer:

$$m = h + D - H \qquad ( 2 )$$

where h represents the thickness of the shallow groundwater action layer in the survey region, D represents the thickness of the vegetation root zone in the survey region, and H represents the groundwater depth in the survey region;
step 7, determination of a water content within the thickness of the available water absorption layer: integrating a water distribution curve ω(h) of an overlapping region in the shallow groundwater action layer to produce a water content ΔQ per unit volume and unit time, which is the water content ΔQ within the thickness m of the available water absorption layer:

$$Δ Q = {\int }_{h - m}^{h} ω ( h ) dh \qquad ( 3 )$$

step 8, determination of the proper plant spacing for a vegetation: calculating a difference between an overall transpiration of the vegetation community and a precipitation supply to produce a quantity Q of soil water absorbed and utilized by the vegetation community per unit time in a cylinder within the entire superimposed thickness, where the soil water comes from groundwater, that is, the quantity Q of soil water is a water supply from the groundwater to the vegetation community:

$$Q = Δ Q \cdot π {r}^{2} = {\int }_{h - m}^{h} ω ( h ) dh \cdot π {r}^{2} = ξ E - P \qquad ( 4 )$$

expressing a relationship between the transpiration of the dominant plant species in the vegetation community and a water support radius r of the vegetation community by the following equation:

$$r = \sqrt{\frac{ξ E - P}{π {\int }_{h - m}^{h} ω ( h ) dh}} \qquad ( 5 )$$

determining the proper plant spacing for the vegetation in the arid region accordingly as follows: L=2r.

Further, in the step 1, the soil parameters are acquired through multi-point sampling and analysis for a soil in the survey region; and the soil water parameters are acquired through field investigation and device acquisition at a growth stage of the vegetation in the survey region.

Further, in the step 2, the vegetation parameters are comprehensively determined according to professional research literature on vegetation roots in Northwest China in combination with measured data of typical vegetation roots excavated on site in the survey region.

Further, in the step 3, the precipitation is acquired by averaging data in 1956 to 2020 from national meteorological stations of China; and the groundwater depth is acquired based on monitoring data of national groundwater monitoring wells in 2018 to 2020 from the Ministry of Water Resources of China.

Further, in the step 4, the transpiration of the dominant plant species in the vegetation community is measured by a weighing lysimeter.

Further, in the step 7, the water distribution curve ω(h) is calibrated with measured soil water parameters in combination with a hyperbolic sine function.

The present disclosure has the following beneficial effects: In the method of the present disclosure, with the vegetation ecological restoration in an arid region as a management control objective, a quantity of water available to vegetation within a superimposed thickness of a vegetation root zone and a shallow groundwater action layer is analyzed to determine a water support radius and a proper plant spacing for a vegetation community. As a result, the ecological restoration can be achieved through the reasonable spaced planting for a vegetation, so as to significantly improve the desertification of oases and effectively protect the water resources in arid regions. The method of the present disclosure can effectively solve the problem of desertification of oases in arid regions, and provides a reliable theoretical and technical support for guiding the ecological rehabilitation and the rational development and utilization of groundwater resources.

The present disclosure is described in further detail below with reference to the accompanying drawings and specific implementations.

### BRIEF DESCRIPTION OF THE DRAWINGS

FIG. 1 is a schematic diagram of interactions among vegetation roots;

FIG. 2 is a schematic diagram of a proper spacing for vegetation distribution determined by water conditions and root functions;

FIG. 3 is a schematic diagram of water consumption of a vegetation community determined by water conditions and root functions; and

FIG. 4 is a flow chart of the method of the present disclosure.

### DETAILED DESCRIPTION OF THE EMBODIMENTS

The present disclosure discloses a method for determining a proper plant spacing for vegetation ecological restoration in an arid region. The method is based on the following principle:

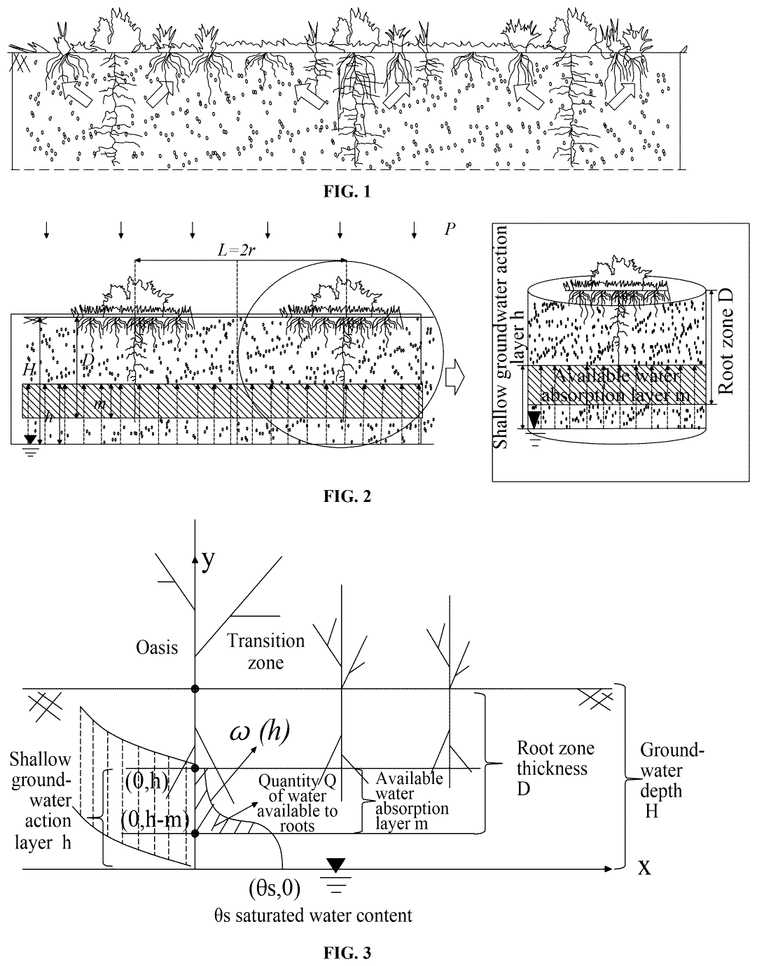

In arid regions (including arid regions and semi-arid regions), the natural vegetation is affected by regional precipitation, groundwater, soil heterogeneity, and human activities, and is often distributed in structures such as striped, annular, and patchy structures. There are interactions among vegetation roots, as shown in FIG. 1. A single stable patchy vegetation community is taken as a whole. In this vegetation community, shrubs grow as a center, and some herbaceous vegetations grow around the center. The roots of shrubs can directly absorb water from the shallow groundwater action layer and allocate the water to the surrounding herbaceous vegetations for absorption and utilization through hydraulic hoisting. Only the soil water within an overlapping part between a root zone and the shallow groundwater action layer of the vegetation community can be absorbed and utilized by vegetation roots, as shown in FIG. 2. Due to a long-term interaction between environmental conditions and the vegetation community, there is a water support radius r for water absorption and utilization of the vegetation community. In a cylinder with r as a radius and depth ranges of the root zone and the shallow groundwater action layer as a height, a stable water absorption-utilization-allocation complex is formed in the vegetation community. Therefore, the key to determining a proper plant spacing for vegetation ecological restoration in an arid region lies in the calculation of a water support radius r for water absorption and utilization of a vegetation community. The traditional analysis of vegetation community distribution patterns in arid regions relies on mathematical models, which lacks the empirical validation. Alternately, the traditional analysis of vegetation community distribution patterns in arid regions is tailored to specific crops, resulting in the lack of universality. Consequently, a water support radius r for water absorption and utilization of a vegetation community is calculated based on a superimposed thickness of a shallow groundwater action layer and a vegetation root zone, and a uniform planting pattern is changed to a proper spaced planting pattern during vegetation ecological restoration, which not only contributes to the conservation and protection of water resources, but also effectively mitigates the desertification.

A process of optimizing a spacing for vegetation planting with a superimposed thickness of a shallow groundwater action layer and a vegetation root zone is as follows: In a region with a large groundwater depth, a vegetation may receive not only a precipitation supply but also a minimal groundwater supply. With the conditions such as vegetations remaining unchanged, a supplied region primarily depends on a superimposed thickness of a shallow groundwater action layer h and a vegetation root zone D. As shown in FIG. 3, there is a soil water distribution curve ω(h) within the shallow groundwater action layer. A water content at a bottom of a shallow groundwater action layer h is a saturated water content θₛ, which is a critical parameter for calibrating the soil water distribution curve within the shallow groundwater action layer. A superimposed thickness of a shallow groundwater action layer h and a vegetation root zone D is denoted as m (an available water absorption layer), a water support radius for a vegetation community in a transition zone is denoted as r, and a transpiration of a dominant species in a vegetation community is denoted as E. Given that a transpiration of another herbaceous vegetation can hardly be quantified directly, a transpiration of the entire community is calculated by multiplying a transpiration E of a dominant species with a coefficient ξ. An effective utilization of a precipitation by a vegetation community is denoted as P. Based on the aforementioned assumption, the soil water within the interval [h-m, h] can be absorbed and utilized by a vegetation community. A water content curve within an overlapping region of a shallow groundwater action layer is integrated to obtain a water content ∫ₕ₋ₘ^{h}ω(h) dh. per unit volume and unit time. A quantity of soil water that can be absorbed and utilized by a vegetation community per unit time in the entire overlapping cylinder is ∫ₕ₋ₘ^{h}ω(h) dh·ηr², and this part of soil water comes entirely from groundwater, namely, a water supply from groundwater to the vegetation community. This part of soil water is equal to a difference between the overall transpiration of the community and a precipitation supply. A water support radius r of the vegetation community can be further deduced according to the above equation.

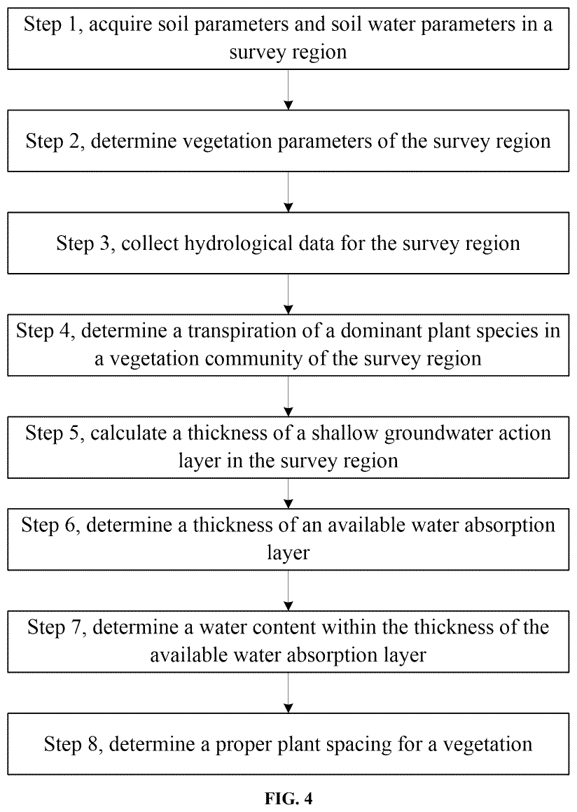

The method of the present disclosure specifically includes the following steps, as shown in FIG. 4:

Step 1. Acquisition of soil parameters and soil water parameters in a survey region: A transition zone in the arid region is selected as the survey region. The multi-point sampling and analysis is conducted for a soil in the survey region to obtain the soil parameters in the survey region, mainly including a soil water content, a soil effective grain diameter, and a soil porosity above a water table. The field investigation and device acquisition are conducted at a growth stage of a vegetation in the survey region to obtain the soil water parameters in the survey region, including a soil water temperature and a soil water surface tension.

Step 2. Determination of vegetation parameters for the survey region: The vegetation parameters for the survey region are determined, including a thickness D of a vegetation root zone in the survey region. The vegetation parameters are comprehensively determined mainly according to professional research literature on vegetation roots in Northwest China in combination with measured data of typical vegetation roots excavated on site in the survey region.

Step 3. Collection of hydrological data of the survey region: The hydrological data of the survey region is collected, mainly including a precipitation P and a groundwater depth H in the survey region. The precipitation is acquired by averaging data in 1956 to 2020 from national meteorological stations of China. The groundwater depth is acquired based on monitoring data of national groundwater monitoring wells in 2018 to 2020 from the Ministry of Water Resources of China.

Step 4. Determination of a transpiration of a dominant plant species in a vegetation community of the survey region: The transpiration E of the dominant plant species in the vegetation community of the survey region is measured. The transpiration of the dominant plant species in the vegetation community is generally measured by a weighing lysimeter.

Step 5. Calculation of a thickness of a shallow groundwater action layer in the survey region: The thickness h of the shallow groundwater action layer in the survey region is calculated based on a theoretical equation for maximum capillary rising height. The shallow groundwater action layer is formed by groundwater under a capillary action and the theoretical equation is as follows:

$$h = \frac{2 σ ( \overline{T} )}{ρ g [ 1.6 ( n - 39.5 \% ) + 0.0774 ] d} \qquad ( 1 )$$

where h represents the thickness of the shallow groundwater action layer in the survey region; T̅ represents an average soil water temperature; σ represents the soil water surface tension; p represents a density of water; g represents an acceleration due to gravity; n represents the soil porosity; and d represents the soil effective grain diameter. The average soil water temperature is produced by averaging soil water temperature data acquired.

Step 6. Determination of a thickness of an available water absorption layer: A superimposed thickness of the vegetation root zone and the shallow groundwater action layer is determined, which is the thickness m of the available water absorption layer. As shown in FIG. 3, the thickness m of the available water absorption layer is as follows:

$$m = h + D - H \qquad ( 2 )$$

where h represents the thickness of the shallow groundwater action layer in the survey region, D represents the thickness of the vegetation root zone in the survey region, and H represents the groundwater depth in the survey region.

Step 7. Determination of a water content within the thickness of the available water absorption layer: A water distribution curve ω(h) of an overlapping region in the shallow groundwater action layer is integrated to produce a water content ΔQ per unit volume and unit time, which is the water content ΔQ within the thickness m of the available water absorption layer:

$$Δ Q = {\int }_{h - m}^{h} ω ( h ) dh \qquad ( 3 )$$

The soil water distribution curve ω(h) within the shallow groundwater action layer of the survey region is calibrated with measured soil water parameters in combination with a hyperbolic sine function. A water content at a bottom of the shallow groundwater action layer h is a saturated water content s. The saturated water content is a crucial parameter for calibrating the water distribution curve within the shallow groundwater action layer.

Step 8. Determination of the proper plant spacing for a vegetation: A proper plant spacing L for the vegetation is determined, as shown in FIG. 2. A difference between an overall transpiration of the vegetation community and a precipitation supply is calculated to produce a quantity Q of soil water absorbed and utilized by the vegetation community per unit time in a cylinder within the entire superimposed thickness. The soil water comes totally from groundwater, that is, the quantity Q of soil water is a water supply from the groundwater to the vegetation community:

$$Q = Δ Q \cdot π {r}^{2} = {\int }_{h - m}^{h} ω ( h ) dh \cdot π {r}^{2} = ξ E - P . \qquad ( 4 )$$

As a result, a relationship between the transpiration of the dominant plant species in the vegetation community and a water support radius r of the vegetation community can be expressed by the following equation:

$$r = \sqrt{\frac{ξ E - P}{π {\int }_{h - m}^{h} ω ( h ) dh}} . \qquad ( 5 )$$

Accordingly, a proper plant spacing for the vegetation in the arid region that depends on water conditions is determined as follows: L=2r. In this case, there is the optimal effect of ecological restoration, and the conservation and protection of regional water resources can be achieved.

### Example 1

This example is an application example of the above method.

In this example, the Luocheng irrigation region of the Heihe River Basin was selected as a survey region. This survey region is located midstream of the Heihe River Basin and on the north side of the main stream of the Heihe River Basin, is a medium-sized irrigation region at a junction of middle and lower reaches, and has an irrigation area of about 72.73 million mu. This survey region is a typical oasis-transition zone-desert coexisting region. According to the survey, oases with irrigation regions as main bodies are mainly distributed near the main stream of the Heihe River. A periphery of an irrigation region is a transition zone with a width of about 0.5 km to 5 km, and there is sparse vegetation coverage. An area of transition zones has been greatly reduced in recent decades due to irrigation and other reasons. It has been found through remote sensing image interpretation that the area of transition zones has decreased from 15,200 hectares in the 1990s to 8,507 hectares in the current situation, indicating the serious desertification. With reference to the local hydrogeological conditions and meteorological observation data, a spacing for vegetation planting in a transition zone was optimized with a superimposed thickness of a shallow groundwater action layer and a vegetation root zone to improve the desertification.

Through the continuous field investigation and fixed-point observation from 2018 to 2021 based on the distribution of field investigation and sampling points in the survey region, a total of 30 vegetation community sampling points were established across the survey region. At each sampling point, the investigated content included a vegetation community type, a vegetation root depth, a groundwater depth, a soil water content, a soil effective grain diameter, a soil porosity, etc. Based on the monitoring data from national meteorological rainfall stations of China, an average multi-year precipitation in the survey region was calculated to be 78 mm. According to three years of experimental data from the Minqin Desert Control Comprehensive Experimental Station that was measured by a weighing lysimeter, an annual transpiration of the Haloxylon vegetation community was determined to be 1.41 m³. Based on dry matter amounts of vegetations, it was estimated that a weight of plants other than a dominant plant species in the community was about 10% of a weight of the dominant plant species. Therefore, a coefficient & was assigned a value of 1.1.

A growth stage for vegetations in a transition zone of the Luocheng irrigation region of the Heihe River Basin is mainly from June to September, and a peak flourishing stage for vegetations is August. Thus, a large number of field investigations were conducted in August. A main temperature range of soil water measured by a WET Sensor portable soil water three-parameter measuring instrument was 10° C. to 30° C., and an average temperature was T̅=20° C. A soil water surface tension was σ=72.5*10⁻³ N/m.

With reference to the research literature “Roots of Grassland Plants in Northern China” on vegetation roots in Northern China and the length data measured for the typical vegetation roots excavated in field investigations, the statistical analysis was conducted to determine that a root length range for the Haloxylon community was 1.50 m to 7.00 m and a thickness of a vegetation root zone was 7.00 m. Based on a theoretical equation for maximum capillary rising height, with a density of water as 1,000 kg/m3 and an acceleration due to gravity as 9.81 m/s², a thickness of a shallow groundwater action layer was calculated to be 1.29 m, and a critical groundwater depth of a vegetation community with Haloxylon as a dominant species at a boundary between an oasis and a transition zone was 7.49 m to 7.89 m.

The above related parameters were substituted into a corresponding calculation formula to calculate a proper plant spacing for Haloxylon. Calculation results showed that a superimposed thickness of a vegetation root zone and a shallow groundwater action layer with Haloxylon as a dominant species was a thickness of an available water absorption layer: m=0.40 m to 0.80 m. Thus, a water support radius for the vegetation community with Haloxylon as a dominant species was r=1.02 m to 1.64 m, and a proper plant spacing was about L=2.04 m to 3.28 m.

A plant spacing for vegetation ecological restoration can be optimized to alleviate the oasis desertification and improve the conservation and utilization of water resources.

Finally, it should be noted that the above are merely intended to describe, rather than to limit the technical solutions of the present disclosure. Although the present disclosure is described in detail with reference to the preferred embodiments, those of ordinary skill in the art should understand that modifications or equivalent replacements may be made to the technical solutions of the present disclosure without departing from the spirit and scope of the technical solutions of the present disclosure.

What is claimed is:

1. A method for determining a proper plant spacing for vegetation ecological restoration in an arid region, comprising the following steps:
step 1, acquisition of soil parameters and soil water parameters in a survey region: selecting a transition zone in the arid region as the survey region, and acquiring the soil parameters and the soil water parameters in the survey region, wherein the soil parameters comprise a soil water content, a soil effective grain diameter, and a soil porosity above a water table, and the soil water parameters comprise a soil water temperature and a soil water surface tension;
step 2, determination of vegetation parameters for the survey region: determining the vegetation parameters for the survey region, wherein the vegetation parameters comprise a thickness D of a vegetation root zone in the survey region;
step 3, collection of hydrological data of the survey region: collecting the hydrological data of the survey region, wherein the hydrological data comprises a precipitation P and a groundwater depth H in the survey region;
step 4, determination of a transpiration of a dominant plant species in a vegetation community of the survey region: measuring the transpiration E of the dominant plant species in the vegetation community of the survey region;
step 5, calculation of a thickness of a shallow groundwater action layer in the survey region: calculating the thickness h of the shallow groundwater action layer in the survey region based on a theoretical equation for maximum capillary rising height, wherein the shallow groundwater action layer is formed by groundwater under a capillary action and the theoretical equation is as follows:
$$h = \frac{2 σ ( \overline{T} )}{ρ g [ 1.6 ( n - 39.5 \% ) + 0.0774 ] d} \qquad ( 1 )$$
wherein h represents the thickness of the shallow groundwater action layer in the survey region; T̅ represents an average soil water temperature; σ represents the soil water surface tension; p represents a density of water; g represents an acceleration due to gravity; n represents the soil porosity; and d represents the soil effective grain diameter;
step 6, determination of a thickness of an available water absorption layer: determining a superimposed thickness of the vegetation root zone and the shallow groundwater action layer, wherein the superimposed thickness is the thickness m of the available water absorption layer:
$$m = h + D - H \qquad ( 2 )$$
wherein h represents the thickness of the shallow groundwater action layer in the survey region, D represents the thickness of the vegetation root zone in the survey region, and H represents the groundwater depth in the survey region;
step 7, determination of a water content within the thickness of the available water absorption layer: integrating a water distribution curve ω(h) of an overlapping region in the shallow groundwater action layer to produce a water content ΔQ per unit volume and unit time, wherein the water content ΔQ per unit volume and unit time is the water content ΔQ within the thickness m of the available water absorption layer:
$$Δ Q = {\int }_{h - m}^{h} ω ( h ) dh \qquad ( 3 )$$
and
step 8, determination of the proper plant spacing for a vegetation: calculating a difference between an overall transpiration of the vegetation community and a precipitation supply to produce a quantity Q of soil water absorbed and utilized by the vegetation community per unit time in a cylinder within the superimposed thickness, wherein the soil water comes from the groundwater, that is, the quantity Q of the soil water is a water supply from the groundwater to the vegetation community:
$$Q = Δ Q \cdot π {r}^{2} = {\int }_{h - m}^{h} ω ( h ) dh \cdot π {r}^{2} = ξ E - P \qquad ( 4 )$$
expressing a relationship between the transpiration of the dominant plant species in the vegetation community and a water support radius r of the vegetation community by the following equation:
$$r = \sqrt{\frac{ξ E - P}{π {\int }_{h - m}^{h} ω ( h ) dh}} \qquad ( 5 )$$
and
determining the proper plant spacing for the vegetation in the arid region accordingly as follows: L=2r.

2. The method for determining the proper plant spacing for vegetation ecological restoration in the arid region according to claim 1, wherein in the step 1, the soil parameters are acquired through multi-point sampling and analysis for a soil in the survey region; and the soil water parameters are acquired through field investigation and device acquisition at a growth stage of the vegetation in the survey region.

3. The method for determining the proper plant spacing for vegetation ecological restoration in the arid region according to claim 1, wherein in the step 2, the vegetation parameters are comprehensively determined according to professional research literature on vegetation roots in Northwest China in combination with measured data of typical vegetation roots excavated on site in the survey region.

4. The method for determining the proper plant spacing for vegetation ecological restoration in the arid region according to claim 1, wherein in the step 3, the precipitation is acquired by averaging data in 1956 to 2020 from national meteorological stations of China; and the groundwater depth is acquired based on monitoring data of national groundwater monitoring wells in 2018 to 2020 from the Ministry of Water Resources of China.

5. The method for determining the proper plant spacing for vegetation ecological restoration in the arid region according to claim 1, wherein in the step 4, the transpiration of the dominant plant species in the vegetation community is measured by a weighing lysimeter.

6. The method for determining the proper plant spacing for vegetation ecological restoration in the arid region according to claim 1, wherein in the step 7, the water distribution curve ω(h) is calibrated with the soil water parameters in combination with a hyperbolic sine function.
